(19) United States
(12) Patent Application Publication
(10) Pub. No.: US 2013/0088444 A1
(43) Pub. Date: Apr. 11, 2013

(54) METHOD OF DRIVING TOUCH DISPLAY PANEL AND TOUCH DISPLAY APPARATUS FOR PERFORMING THE SAME

(71) Applicants: Chul KIM, Gyeonggi-do (KR); Ji-Woong KIM, Jeonju-si (KR); Su-Bin PARK, Incheon (KR); Seung-Hwan MOON, Asan-si (KR); Byoung-Jun LEE, Gyeonggi-do (KR)

(72) Inventors: Chul KIM, Gyeonggi-do (KR); Ji-Woong KIM, Jeonju-si (KR); Su-Bin PARK, Incheon (KR); Seung-Hwan MOON, Asan-si (KR); Byoung-Jun LEE, Gyeonggi-do (KR)

(73) Assignee: SAMSUNG DISPLAY CO., LTD., GYEONGGI-DO (KR)

(21) Appl. No.: 13/608,167

(22) Filed: Sep. 10, 2012

(30) Foreign Application Priority Data
Oct. 10, 2011 (KR) 10-2011-0102917

(51) Int. Cl. G06F 3/041

(52) U.S. Cl. 345/173

(57) ABSTRACT

A method of driving a touch display panel includes sequentially providing gate signals to a plurality of gate lines, outputting data signals to a plurality of data lines, the data lines being disposed on the first surface and crossing the gate lines, and reading out a first sensing signal through a plurality of sensing lines in response to the gate signals. The gate lines are disposed on a first surface of a base substrate, the touch display panel including the base substrate. The data signals are synchronized with the gate signals. The sensing line is disposed on a second surface of the base substrate, the second surface being opposite to the first surface.

### CROSS-REFERENCE TO RELATED APPLICATION

This application claims priority under 35 U.S.C. §119 to Korean Patent Application No. 10-2011-0102917, filed on Oct. 10, 2011, in the Korean Intellectual Property Office (KIPO), the contents of which application are incorporated by reference herein in their entireties.

### BACKGROUND

1. Field of Disclosure

The present disclosure of invention relates to a method of driving a touch-responsive display panel and to a touch-responsive display apparatus which is configured for performing the method of driving the touch-responsive display panel. More particularly, example embodiments relate to a method of driving a touch display panel using a gate signal.

2. Discussion of Related Technology

In a recently developed touch display apparatus, a conductive material such as a finger touches the touch display apparatus, and then an electric capacitance of a touch sensor is changed, so that a touch position may be detected by the change of the electric capacitance of the touch sensor.

For example, such a touch display apparatus may include a first substrate and a spaced apart second substrate. The first substrate includes a gate line, a data line, a switching element electrically connected to the gate and data lines, and a pixel electrode electrically connected to the switching element. The second substrate includes a common electrode facing the pixel electrode and disposed on a first surface of the second substrate, where a touch sensor sensing a touch position based on change of capacitance is disposed on a second surface of the second substrate opposite to the first surface.

The touch sensor may be used by detecting electric capacitance of the touch sensor before, during and after the touching event to thus sense the location and duration of the touch event by sensing change in capacitance. However, the change of the electric capacitance is sometimes too small to be clearly detected. In addition, such a capacitance-based touch sensor tends to be sensitive to an external noise.

For example, external noise that affects the touch sensor may include a noise radiated from a radio or other signal transmitter of the touch display apparatus or from a power supply, or a noise conducted by a power source line, and a noise created due to temperature and/or humidity changes and so on.

Because of the above-mentioned noises, the capacitance-based touch sensor may fail to properly detect the touch, its position and/or its duration and may therefore malfunction, and thus, the touch sensor may be operated badly such that system software that relies on proper detection of the touch, of its position and/of or its duration and may also therefore malfunction and user commands to the software based on touching are not properly obeyed.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

Example embodiments of the present disclosure of invention provide a method of driving a touch-responsive display panel capable of improving a signal-to-noise ratio (SNR).

Example embodiments of the present disclosure of invention also provide a touch display apparatus for performing the method of driving the touch display panel.

According to an example embodiment of the invention, a method of driving a touch display panel includes sequentially providing gate signals to a plurality of gate lines, outputting data signals to a plurality of data lines, the data lines being disposed on the first surface and crossing the gate lines, and reading out a first sensing signal through a plurality of sensing lines in response to the gate signals. The gate lines are disposed on a first surface of a base substrate, the touch display panel including the base substrate. The data signals are synchronized with the gate signals. The sensing line is disposed on a second surface of the base substrate, the second surface being opposite to the first surface.

In an example embodiment, the method of driving a touch display panel may further includes detecting a touch position using the first sensing signal

In an example embodiment, the detecting the touch position may include integrating the first sensing signal which is read out from at least one sensing line of the sensing lines to generate a second sensing signal, in response to each of n gate signals applied to n gate lines of the gate lines.

In an example embodiment, the detecting the touch position may include generating an integral signal based on a gate control signal controlling the n gate signals, and integrating the first sensing signal in response to the integral signal.

In an example embodiment, the detecting the touch position includes generating an integral signal based on the n gate signals and integrating the first sensing signal in response to the integral signal.

In an example embodiment, a high level of the second sensing signal may be substantially same as a high level of the gate signal.

In an example embodiment, each of the n gate signals may have the high level. The integral signal may be activated during a period in which the consecutive n gate signals have the high level.

In an example embodiment, each of the n gate signals may have the high level. The integral signal may be activated during a period in which the high levels of the consecutive two gate signals overlap with each other.

In an example embodiment, each of the n gate signals may have the high level. The integral signal may be activated during a period in which the high levels of the consecutive n gate signals overlap with each other.

According to another example embodiment of the invention, a touch display panel includes a first substrate including a first base substrate and a common electrode disposed on the first base substrate, and a second substrate including a unit touch sensor. The unit touch sensor includes a second base substrate, a plurality of gate lines disposed on a first surface of the second base substrate, and at least one sensing line disposed on a second surface of the second base substrate and crossing the gate lines. The first surface faces the first base substrate. The second surface faces the first surface.

In an example embodiment, the second substrate may further include a data line substantially parallel with the sensing line on the first surface of the second base substrate. Each of the sensing lines may correspond to each of the data lines.

In an example embodiment, the second substrate may further include a data line substantially parallel with the sensing line on the first surface of the second base substrate. Each of the sensing line may correspond to at least two data lines.

According to still another example embodiment of the invention, a touch display apparatus includes a touch display panel and a driving part. The touch display panel includes a first substrate including a first base substrate and a common electrode disposed on the first base substrate and a second substrate including a unit touch sensor. The unit touch sensor includes a second base substrate, a plurality of gate lines disposed on a first surface of the second base substrate, and a plurality of sensing lines disposed on a second surface of the second base substrate and crossing the gate lines. The first surface facing the first base substrate. The second surface facing the first surface. The driving part sequentially provides gate signals to the gate lines, and reads out a first sensing signal through the sensing lines in response to the gate signals.

In an example embodiment, the driving part may include a gate driving part sequentially providing the gate signals to the gate lines, a sensing driving part reading out the first sensing signal from the sensing lines in response to each of the gate signals, a display panel timing controller generating a gate control signal controlling the gate signal, and a sensing timing controller generating an integral signal integrating the first sensing signal in response to the gate signals or the gate control signal.

In an example embodiment, the sensing driving part may include a integrating circuit integrating the first sensing signal to generate a second sensing signal having a level substantially same as a level of the gate signal.

In an example embodiment, the sensing driving part may read out the first sensing signal from the unit touch sensor. The unit touch sensor may read out the first sensing signal from at least one sensing line of the sensing lines in response to each of the n gate signals applied to n gate lines of the gate lines.

In an example embodiment, the sensing timing controller may generate the integral signal integrating the first sensing signal during a minimum noise period based on the gate control signal.

In an example embodiment, each of the gate signals may have a high level. The sensing timing controller may generate an integral signal integrating the first sensing signal during a period in which the consecutive gate signals have the high level.

In an example embodiment, each of the gate signals may have a high level. The sensing timing controller may generate an integral signal integrating the first sensing signal during a period in which the high levels of the consecutive two gate signals overlap with each other.

In an example embodiment, each of the gate signals has a high level. The sensing timing controller may generates an integral signal integrating the first sensing signal during a period in which the high levels of the consecutive gate signals overlap with each other.

According to the example embodiments of the present invention, a touch unit, which detects a touch position by detecting changes of an electrostatic capacity of a conductive material, is formed on a first substrate on which a pixel electrode is formed, so that the SNR may be improved.

In addition, a gate signal having a relatively high level is used as an input signal of the touch unit, so that a relatively high output signal may be obtained. Thus, the SNR may be improved.

In addition, an integral signal which integrates the output signal during a noise-minimum period using a gate control signal controlling the gate signal is generated, so that the SNR may be improved.

Charging periods of consecutive gate signals overlap with each other, so that the period in which the output signal is integrated may be decreased. Thus, the SNR may be improved.

### BRIEF DESCRIPTION OF THE DRAWINGS

The above and other features of the invention will become more apparent by describing in detail example embodiments thereof with reference to the accompanying drawings, in which:

FIG. 1 is a cross-sectional view illustrating a touch display apparatus according to an example embodiment of the invention;

FIG. 2 is plan view illustrating the touch display apparatus of FIG. 1;

FIG. 3 is a block diagram illustrating a sensing driving part;

FIG. 4 is a plan view illustrating a unit touch sensor of FIG. 2;

FIG. 5 is a timing diagram of signals driving the unit touch sensor of FIG. 4;

FIG. 6 is a timing diagram of signals driving a unit touch sensor of a touch display apparatus according to another example embodiment of the invention;

FIG. 7 is a timing diagram of signals driving a unit touch sensor of a touch display apparatus according to still another example embodiment of the invention; and

FIG. 8 is a timing diagram of signals driving a unit touch sensor of a touch display apparatus according to still another example embodiment of the invention.

### DETAILED DESCRIPTION

Hereinafter, the invention will be explained in detail with reference to the accompanying drawings.

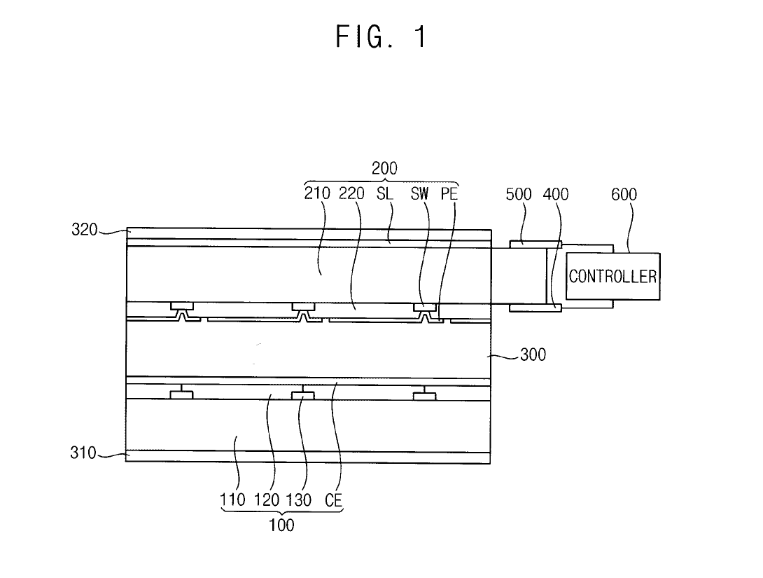

FIG. 1 is a cross-sectional view illustrating a touch display apparatus according to an example embodiment of the invention.

Referring to FIG. 1, the touch display apparatus according to the present example embodiment includes a touch display panel and a driving part.

The touch display panel includes a first substrate 100, a second substrate 200 opposite to the first substrate 100, and a liquid crystal layer 300 disposed between the first substrate 100 and the second substrate 200. The touch display panel may further include a first polarizing plate 310 and a second polarizing plate 320.

The first substrate 100 includes a first base substrate 110 and a color filter layer 120 disposed on a first surface of the first base substrate 110, a light blocking pattern 130 and a common electrode CE.

In the present example embodiment, the color filter layer 120 and the light blocking pattern 130 are formed on the first substrate 100, but alternatively at least one of the color filter layers 120 and the light blocking pattern 130 may be formed on the second substrate 200.

The polarizing plate 310 may be disposed on a second surface of the first base substrate 110. The second surface is opposite to the first surface of the first base substrate 110.

The second substrate 200 includes a second base substrate 210, a switching element SW of a pixel portion, an array layer 220 and an pixel electrode PE which are disposed on a first surface of the second substrate 200, and a sensing line SL disposed on a second surface of the second substrate 200. The first surface of the second base substrate 210 faces the first surface of the first base substrate 110. The second surface of the second substrate 200 is opposite to the first surface of the second base substrate 210.

The second polarizing plate 320 may be disposed on the second surface of the second substrate 200 on which the sensing line SL is formed.

Accordingly, the sensing line SL is formed on the second base substrate 210 on which the switching element SW is formed. Thus, a noise generated by the common electrode CE may be more decreased compared to the noise generated when the sensing line SL is formed on the first base substrate 110. Thus, a signal-to-noise ratio (SNR) may be improved.

The droving part includes a display panel driving part 400, a sensing driving part 500 and a controller 600.

The display panel driving part 400 applies a voltage to the common electrode CE and the pixel electrode PE, so that an arrangement of liquid crystal molecules between the common electrode CE and the pixel electrode PE is changed. Thus, an image is displayed.

The sensing driving part 500 reads out a sensing voltage from the sensing line SL and integrates the sensing voltage to generate an output voltage.

The controller 600 includes a display panel timing controller 610, and a sensing timing controller 620.

The display panel timing controller 610 is connected to the display panel driving part 400. The display panel timing controller 610 receives an image data and a control signal, and provides a gate driving signal and a data driving signal in response to the control signal to the display panel driving part 400. In addition, the display panel timing controller 610 provides the gate driving signal to the sensing timing controller 620.

The sensing timing controller 620 is connected to the sensing driving part 500 and the display panel timing controller 610. The sensing timing controller 620 generates an integral signal for optimally integrating the sensing voltage and provides the integral signal to the sensing driving part 500, based on the gate driving signal.

Accordingly, the sensing timing controller 620 receives the output voltage which is integrated by the sensing driving part 500 based on the integral signal, and detects a touch position based on the output voltage.

The display panel timing controller 610 and the sensing timing controller 620 may be mounted on one printed circuit board (PCB).

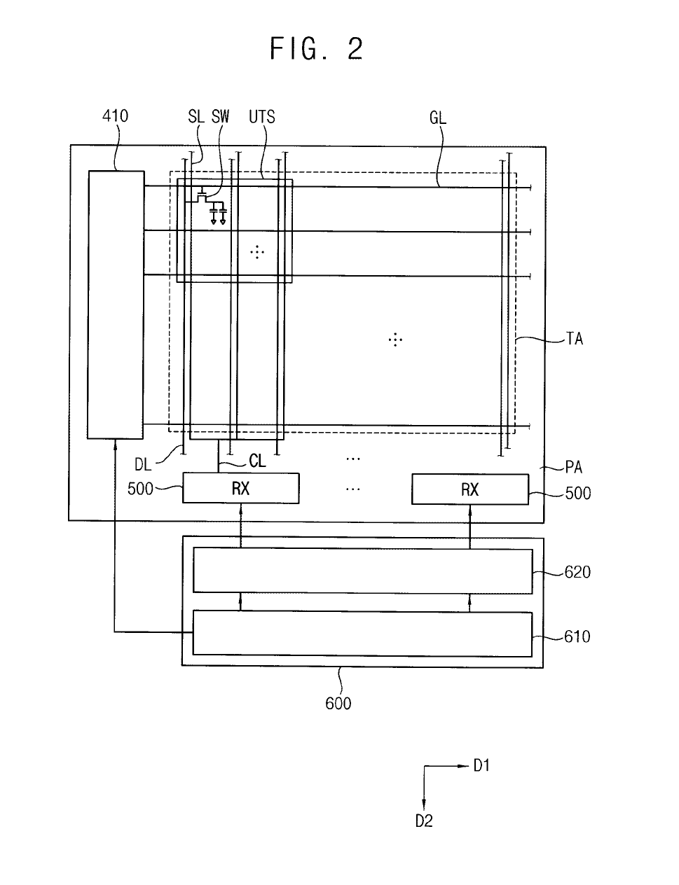

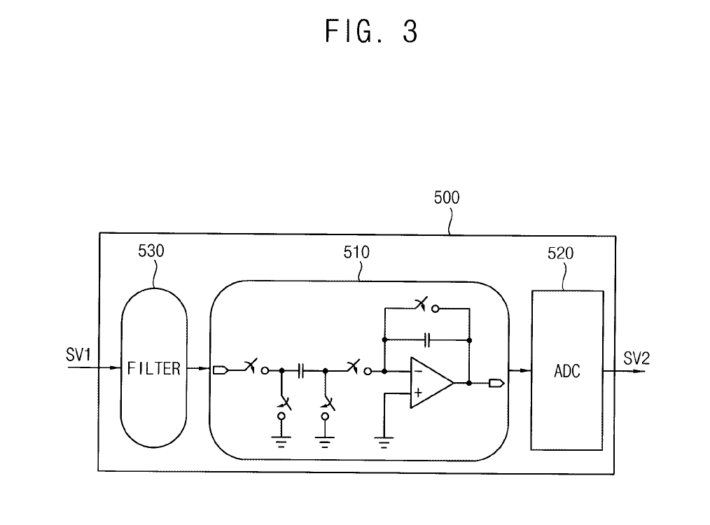

FIG. 2 is plan view illustrating the touch display apparatus of FIG. 1. FIG. 3 is a block diagram illustrating a sensing driving part.

Referring to FIGS. 1 to 3, a second substrate 200 of the touch display panel includes a plurality of gate lines GL, a plurality of data lines DL, a plurality of sensing lines SL and a plurality of connecting lines CL.

The gate line GL extends along a first direction D1 on a first surface of the second base substrate 210. The gate lines GL applies a gate signal to a gate electrode of the switching element SW disposed on the first surface of the second base substrate 210. Thus, the switching element SW is driven.

The data line DL extends along a second direction D2 crossing the first direction D1 on the first surface of the second base substrate 210. The data line DL and the sensing line SL are parallel with each other. The data line DL applies a data signal to a source electrode of the switching element SW, so that the data signal is provided to the pixel electrode PE connected to a drain electrode of the switching element SW.

The sensing line SL extends along the second direction D2 on the second surface of the second base substrate 210.

A unit touch sensor UTS includes n gate lines GL, m sensing lines SL, and the second base substrate 210 between the n gate lines GL and the m sensing lines SL. Here, n may be a natural number and be 2 or more, m may be a natural number and be 1 or more, and n may be same as m or not.

The connecting line CL is disposed in a peripheral area PA surrounding a touch area TA. A crossing point at which the gate line GL and the sensing line SL cross with each other, is formed at the area TA. The connecting line CL connects the sensing line SL to the sensing driving part 500.

When m is 2 or more, the sensing lines SL are electrically connected to each other through the connecting line CL.

As described in FIG. 2, each of the sensing lines SL may correspond to each of the data lines. The sensing line SL may include a transparent conductive oxide. Thus, the sensing line SL may not overlap with the data line regardless of an aperture ratio.

Alternatively, the sensing line SL may correspond to a plurality of the data lines DL. In addition, the sensing line SL may include a metal such as a copper and etc. Thus, the sensing line SL may overlap with the data line DL.

The display panel driving part 400 includes a gate driving part 410 and a data driving part (not shown). The gate driving part 410 is connected to first ends of the gate lines GL. The gate driving part 410 sequentially provides gate signals to the gate lines GL. The data driving part is connected to first ends of the data lines. The data driving part sequentially provides data signals synchronized with the gate signals to the data lines.

The sensing driving part 500 is connected to the connecting line CL. The sensing driving part 500 includes an integrating part 510 including an integrating circuit. The sensing driving part 500 may further include an analog-to-digital convertor 520 and a filter 530. The filter may be a noise filter 530 disposed before the integrating part 510.

The integrating circuit integrates the sensing voltage read out from the sensing line SL based on the integral signal received from the sensing timing controller 620 at a noise-minimum period, to generate the output voltage. The output voltage is provided to the sensing timing controller 620.

The number of the sensing driving part 500 and that of the sensing timing controller 620 may be increased according to a size of the touch display panel.

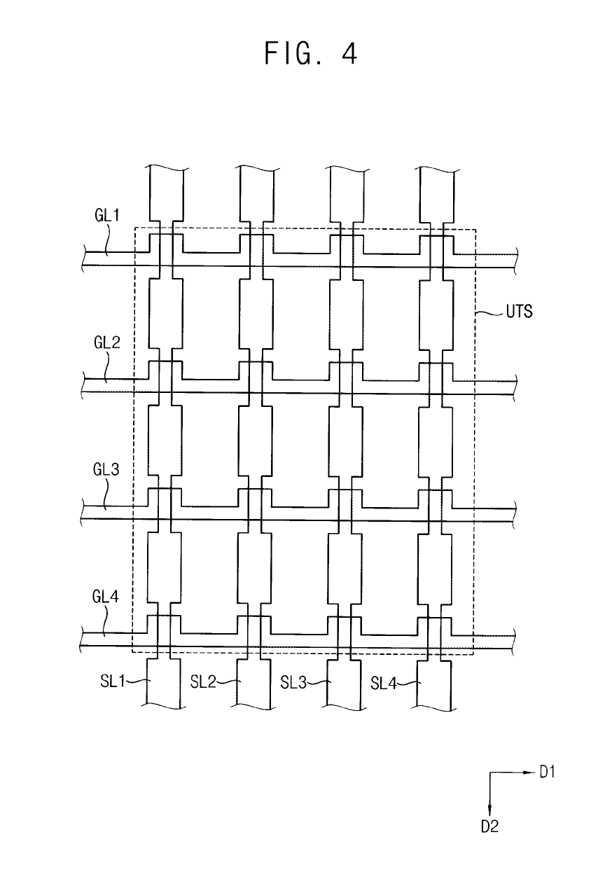

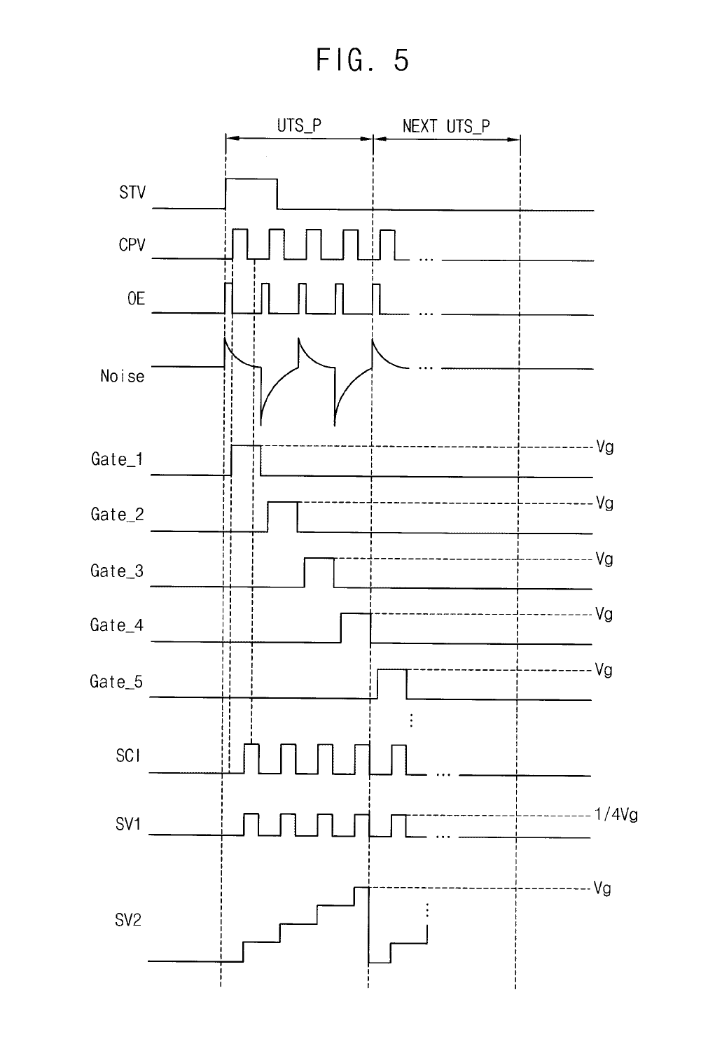

FIG. 4 is a plan view illustrating a unit touch sensor of FIG. 2. FIG. 5 is a timing diagram of signals driving the unit touch sensor of FIG. 4. In FIGS. 4 and 5, a method of driving a unit touch sensor UTS including four gate lines and four sensing lines will be described.

Referring to FIGS. 2, 4 and 5, the unit touch sensor UTS includes first, second, third and fourth gate lines GL1, GL2, GL3 and GL4, first, second, third and fourth sensing lines SL1, SL2, SL3 and SL4, and a second base substrate. The second base substrate is disposed between the first, second, third and fourth gate lines GL1, GL2, GL3 and the GL4, and the first, second, third and fourth sensing lines SL1, SL2, SL3 and SL4.

The display panel timing controller 610 provides a gate starting signal STV, a clock signal CPV and an output enable signal OE to the gate driving part 410 and the sensing timing controller 620.

The gate driving part 410 sequentially provides the first, second, third and fourth gate signals Gate_1, Gate_2, Gate_3 and Gate_4 to the first, second, third and fourth gate lines GL1, GL2, GL3 and the GL4 in every horizontal period based on the gate starting signal STV, the clock signal CPV and the output enable signal OE. The every period in which the first, second, third and fourth gate signals Gate_1, Gate_2, Gate_3 and Gate_4 are sequentially provided, may be defined as a period UTS_P of the unit touch sensor UTS.

The first, second, third and fourth gate signals Gate_1, Gate_2, Gate_3 and Gate_4 drive the switching element SW disposed on the first surface of the second base substrate 210, and drive the unit touch sensor UTS disposed on the second surface of the second base substrate 210 at the same time.

Thus, the first, second, third and fourth gate signals Gate_1, Gate_2, Gate_3 and Gate_4 are control signals of the switching element SW and input signals of the unit touch sensor UTS.

The first, second, third and fourth gate signals Gate_1, Gate_2, Gate_3 and Gate_4 are about 10 times larger than input signals of a conventional touch sensor.

For example, when the input signals of the conventional touch sensor is about 3.3V, an amount of the output signal changed between the output signal of the touch sensor not touched and the output signal of the touch sensor touched may be about 42 mV.

However, when the input signal of the unit touch sensor of the present example embodiment is about 30V, the amount of the output signal changed between the output signal of the touch sensor not touched (a first sensing signal of the unit touch sensor not touched) and the output signal of the touch sensor touched (the first sensing signal of the unit touch sensor touched) may be about 270 mV.

Thus, a level of the input signal inputted into the unit touch sensor increases, a level of the output signal outputted form the unit touch sensor UTS increases. Thus, changing amount of touch signal increases, the touch position may be detected more easily.

In addition, a difference between a level of the output signal of the unit touch sensor and a noise level is larger than a difference between the level of the output signal of the conventional touch sensor and the noise level. In the unit touch sensor of the present example embodiment, the SNR may be improved compared to the conventional touch sensor. For example, a sensing capacitor according to the present example embodiment may have the SNR improved by about 6.4 times compared to a conventional sensing capacitor.

The sensing driving part 500 outputs a first sensing voltage SV1 in response to the first, second, third and fourth gate signals Gate_1, Gate_2, Gate_3 and Gate_4.

The first sensing voltage SV1 includes first to fourth sensing pulses for each of the first to fourth gate signals Gate_1, Gate_2, Gate_3 and Gate_4. The first to fourth gate signals Gate_1, Gate_2, Gate_3 and Gate_4 are applied to the first to fourth gate lines GL1, GL2, GL3 and the GL4. Alternatively, the first to fourth sensing pulses are read out to the connecting line CL in a line through the first to fourth sensing lines SL1, SL2, SL3 and SL4.

When each level of the first to fourth gate signals Gate_1, Gate_2, Gate_3 and Gate_4 is about 30V, each level of the first to fourth sensing pulses is about 30V/4 due to charge sharing. For example, a value which is a level of the gate signal over the number of the gate signals is a level of the sensing pulse.

The sensing driving part 500 integrates the first to fourth sensing pulses using the integrating circuit to generate a second sensing voltage SV2 having a level substantially same as a level of the first to fourth gate signals Gate_1, Gate_2, Gate_3 and Gate_4.

Accordingly, the second sensing voltage SV2 is larger than the output voltage of the conventional sensor, so that the noise may have less affect.

The sensing timing controller 620 generates the integral signal SCI based on the gate starting signal STV, the clock signal CPV and the output enable signal OE, and provides the integral signal SCI to the integrating part 510.

The integrating part 510 integrates the first to fourth sensing pulses at a noise-minimum time generates the second sensing voltage SV2 by. For example, the integral signal SCI is activated during a period in which the clock signal CPV is at the low level and an output enable signal OE is at the low level.

After the fourth sensing pulse is integrated, the sensing timing controller 620 receives the second sensing voltage SV2 to detect a touch position based on the second sensing voltage SV2. For example, the sensing timing controller 620 may detect the second sensing voltage SV2 at a falling edge of the integral signal SCI integrating the fourth sensing pulse.

The sensing timing controller 620 generates and detects the second sensing voltage SV2 at the nose-minimum period in response to the gate control signal, so that the SNR of the second sensing voltage SV2 may be improved.

According to the present example embodiment, the SNR may be improved using the gate signals in which the unit touch sensor UTS has a relatively high level. Thus, the touch position may be detected more easily.

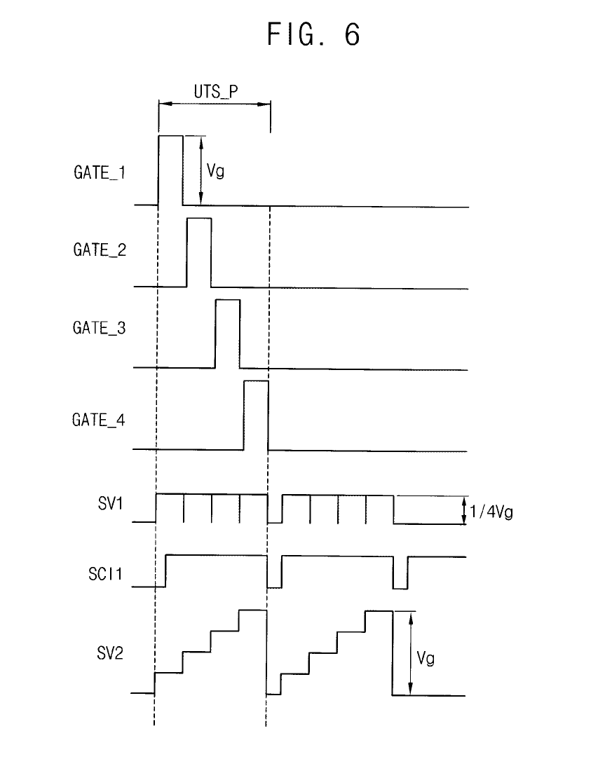

FIG. 6 is a timing diagram of signals driving a unit touch sensor of a touch display apparatus according to another example embodiment of the invention.

The touch display apparatus according to the present example embodiment is substantially same as the touch display apparatus illustrated in FIG. 1 except for an integral signal. The same reference numerals denote the same elements in FIG. 1, and thus any further detailed descriptions concerning the same elements will be omitted.

In FIG. 6, a method of driving a unit touch sensor UTS including four gate lines and four sensing lines will be described.

Referring to FIG. 6, a gate driving part 410 sequentially provides the first, second, third and fourth gate signals Gate_1, Gate_2, Gate_3 and Gate_4 to the first, second, third and fourth gate lines GL1, GL2, GL3 and GL4 based on the gate starting signal STV, the clock signal CPV and the output enable signal OE. A period in which the first, second, third and fourth gate signals Gate_1, Gate_2, Gate_3 and Gate_4 are sequentially provided may be defined as a period of the unit touch sensor UTS_P.

Each of the first, second, third and fourth gate signals Gate_1, Gate_2, Gate_3 and Gate_4 has a high level during a first charging period. Each of the first, second, third and fourth gate signals Gate_1, Gate_2, Gate_3 and Gate_4 sequentially has the high level during the first charging period, and thus a charging period of each of the first, second, third and fourth gate signals Gate_1, Gate_2, Gate_3 and Gate_4 does not overlap with each other.

The sensing timing controller 620 generates the integral signal SCI1 based on the first, second, third and fourth gate signals Gate_1, Gate_2, Gate_3 and Gate_4, and provides the integral signal SCI1 to the integrating part 510 of the sensing driving part 500. For example, the integral signal SCI1 is activated during the first charging period of the first, second, third and fourth gate signals Gate_1, Gate_2, Gate_3 and Gate_4.

The integrating part 510 integrates the first, second, third and fourth sensing pulses in response to the integral signal SCI1, so that the second sensing voltage SV2 is generated.

Thus, the sensing timing controller 620 detects the second sensing voltage SV2, so that a touch position is detected using the second sensing voltage SV2.

For example, the sensing timing controller 620 may detect the second sensing voltage SV2 at a falling edge of the integral signal SCI integrating the fourth sensing pulse.

According to the present example embodiment, the unit touch sensor UTS uses the gate signal having a high level, so that SNR may be improved. Thus, the touch position may be detected more easily.

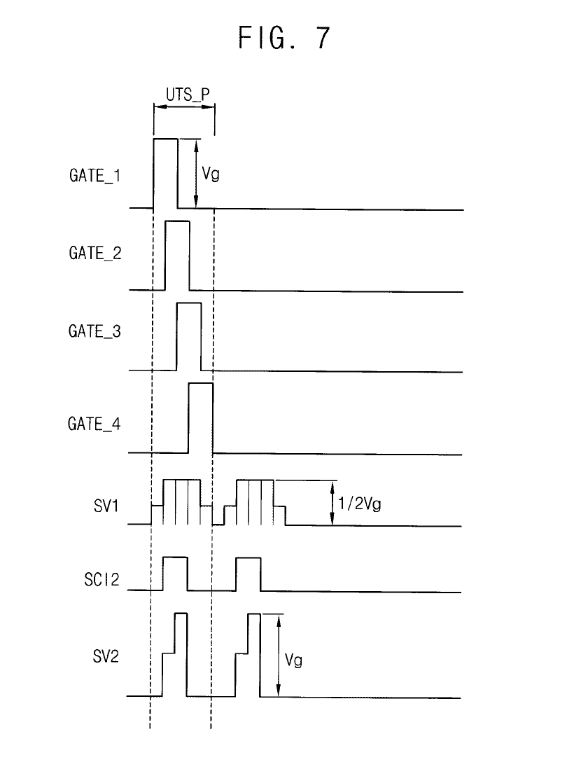

FIG. 7 is a timing diagram of signals driving a unit touch sensor of a touch display apparatus according to still another example embodiment of the invention.

The touch display apparatus according to the present example embodiment is substantially same as the touch display apparatus illustrated in FIG. 1 except for an integral signal. The same reference numerals denote the same elements in FIG. 1, and thus any further detailed descriptions concerning the same elements will be omitted.

In FIG. 7, a method of driving a unit touch sensor UTS including four gate lines and four sensing lines will be described.

Referring to FIG. 7, a gate driving part 410 sequentially provides the first, second, third and fourth gate signals Gate_1, Gate_2, Gate_3 and Gate_4 to the first, second, third and fourth gate lines GL1, GL2, GL3 and GL4 based on the gate starting signal STV, the clock signal CPV and the output enable signal OE. A period in which the first, second, third and fourth gate signals Gate_1, Gate_2, Gate_3 and Gate_4 are sequentially provided may be defined as a period of the unit touch sensor UTS_P .

Each of the first, second, third and fourth gate signals Gate_1, Gate_2, Gate_3 and Gate_4 has a high level during a first charging period and a second charging period. Width of the first charging period and width of the second charging period are substantially same with each other.

A pixel electrode PE connected to the first, second, third and fourth gate lines GL1, GL2, GL3 and GL4 is charged in advance in the first charging period. Thus, even though a driving frequency increases, the pixel electrode PE is further charged in the first charging period right before the second charging period, to prevent the pixel electrode PE from being uncharged or less charged. Accordingly, the pixel electrode PE is charged with a relatively increased period, which means that a charging time for the pixel electrode PE is sufficiently guaranteed.

Consecutive two gate signals of the first, second, third and fourth gate signals Gate_1, Gate_2, Gate_3 and Gate_4 overlap with each other.

For example, the second charging period of the first gate signal Gate_1 and the first charging period of the second gate signal Gate_2 overlap with each other. The second charging period of the second gate signal Gate_2 and the first charging period of the third gate signal Gate_3 overlap with each other. The second charging period of the third gate signal Gate_3 and the first charging period of the fourth gate signal Gate_4 overlap with each other.

The first sensing signal SV1 in a period in which the consecutive two gate signals overlap with each other may have a voltage higher than that of the first sensing signal SV1 in a period in which the consecutive two gate signals do not overlap with each other due to the charge sharing.

For example, the first sensing signal SV1 in a period in which the consecutive two gate signals overlap with each other may have a voltage of a ½ level of the gate signal. Alternatively, the first sensing signal SV1 in a period in which the consecutive two gate signals do not overlap with each other may have a voltage of a ¼ level of the gate signal.

The sensing timing controller 820 generates the integral signal SCI2 based on the first, second, third and fourth gate signals Gate_1, Gate_2, Gate_3 and Gate_4, and provides the integral signal SCI1 to the integrating part 510 of the sensing driving part 500.

The integral signal SCI2 may be activated in the period in which the consecutive two gate signals overlap with each other.

For example, the integral signal SCI2 may be activated during two periods of following periods to make the level of the second sensing signal SV2 be substantially same as a level of the gate signal Vg. The following periods includes a period in which the first gate signal Gate_1 and the second gate signal Gate_2 overlap with each other, a period in which the second gate signal Gate_2 and the third gate signal Gate_3 overlap with each other, and a period in which the third gate signal Gate_3 and the fourth gate signal Gate_4 overlap with each other.

Alternatively, the integral signal SCI2 may be activated from the first charging period of the first gate signal Gate_1 to a period in which the level of the second sensing signal SV2 is larger than the level of the gate signal Vg, so that the integrating part 510 may integrate the first sensing signal SV1 from the first charging period of the first gate signal Gate_1 to the period in which the level of the second sensing signal SV2 is larger than the level of the gate signal Vg.

According to the present example embodiment, the gate signals have the first charging period, so that a charging time for charging the pixel electrode PE may be sufficiently guaranteed. Thus, the pixel electrode PE may be prevented from being uncharged or less charged.

In addition, the integrating part 510 decreases an integral period integrating the first sensing signal, so that power consumption may be decreased.

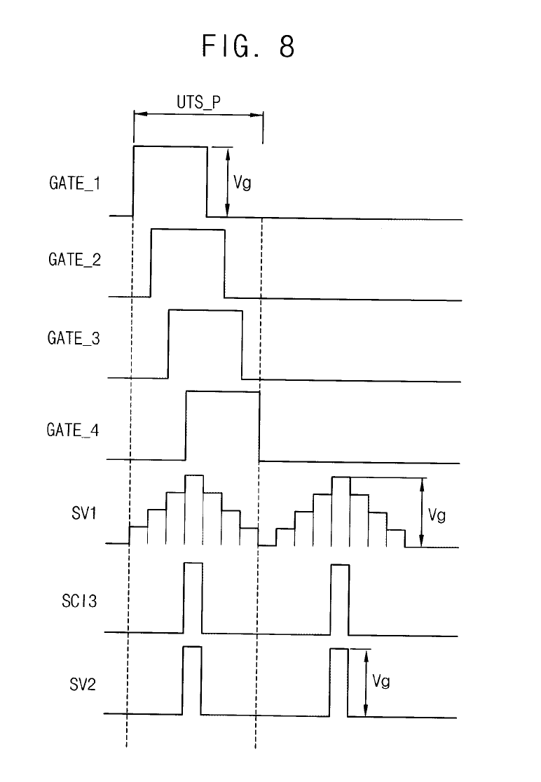

FIG. 8 is a timing diagram of signals driving a unit touch sensor of a touch display apparatus according to still another example embodiment of the invention.

The touch display apparatus according to the present example embodiment is substantially same as the touch display apparatus illustrated in FIG. 1 except for an integral signal. The same reference numerals denote the same elements in FIG. 1, and thus any further detailed descriptions concerning the same elements will be omitted.

In FIG. 8, a method of driving a unit touch sensor UTS including four gate lines and four sensing lines will be described.

Referring to FIG. 8, a gate driving part 410B sequentially provides the first, second, third and fourth gate signals Gate_1, Gate_2, Gate_3 and Gate_4 to the first, second, third and fourth gate lines GL1, GL2, GL3 and GL4 based on the gate starting signal STV, the clock signal CPV and the output enable signal OE. A period in which the first, second, third and fourth gate signals Gate_1, Gate_2, Gate_3 and Gate_4 are sequentially provided may be defined as a period of the unit touch sensor UTS_P.

Each of the first, second, third and fourth gate signals Gate_1, Gate_2, Gate_3 and Gate_4 has a high level during a first charging period and a second charging period. Width of the first charging period may have three times larger than width of the second charging period.

A pixel electrode PE connected to the first, second, third and fourth gate lines GL1, GL2, GL3 and GL4 is charged in advance in the first charging period. Thus, even though a driving frequency increases, the pixel electrode PE is further charged in the first charging period right before the second charging period, to prevent the pixel electrode PE from being uncharged or less charged. Accordingly, the pixel electrode PE is charged with a relatively increased period, which means that a charging time for the pixel electrode PE is sufficiently guaranteed.

Consecutive four gate signals which are the first, second, third and fourth gate signals Gate_1, Gate_2, Gate_3 and Gate_4 overlap with each other.

For example, ⅔ of the first charging period of the first gate signal Gate_1 and the second charging period of the first gate signal Gate_1 overlap with the first charging period of the second gate signal Gate_2. ⅔ of the first charging period of the second gate signal Gate_2 and the second charging period of the second gate signal Gate_2 overlap with the first charging period of the third gate signal Gate_3. ⅔ of the first charging period of the third gate signal Gate_3 and the second charging period of the third gate signal Gate_3 overlap with the first charging period of the fourth gate signal Gate_4.

Accordingly, the first gate signal Gate_1 overlaps with the first charging period of each of the third gate signal Gate_3 and the fourth gate signal Gate_4 as well as the second gate signal Gate_2

As the number of the periods in which the consecutive first, second, third and fourth gate signals Gate_1, Gate_2, Gate_3 and Gate_4 overlap with each other increases, the level of the first sensing signal SV1 increases due to the charge sharing.

For example, the first sensing signal SV1 has ¼ level of voltage of the gate signal during the first charging period of the first gate signal Gate_1 in which the first gate signal Gate_1 overlaps with none of the second, third and fourth gate signals Gate_2, Gate_3 and Gate_3. The first sensing signal SV1 has 2/4 level of voltage of the gate signal during the first charging period of the first gate signal Gate_1 in which the first gate signal Gate_1 overlaps with the second gate signal Gate_2. The first sensing signal SV1 has ¾ level of voltage of the gate signal during the first charging period of the first gate signal Gate_1 in which the first gate signal Gate_1 overlaps with the second and third gate signals Gate_2 and Gate_3. The first sensing signal SV1 has a level of voltage of the gate signal during the first charging period of the first gate signal Gate_1 in which the first gate signal Gate_1 overlaps with the second, third and fourth gate signals Gate_2, Gate_3 and Gate_4.

The sensing timing controller 820 generates the integral signal SCI3 based on the first, second, third and fourth gate signals Gate_1, Gate_2, Gate_3 and Gate_4, and provides the integral signal SCI1 to the integrating part 510 of the sensing driving part 500.

The integral signal SCI3 may be activated in the period in which the consecutive gate signals overlap with each other.

For example, the integral signal SCI3 may be activated during a period in which all of the first, second, third and fourth gate signals Gate_1, Gate_2, Gate_3 and Gate_4 overlap with each other to make the level of the second sensing signal SV2 be substantially same as a level of the gate signal Vg.

Alternatively, the integrating part 510 does not operate during the period in which all of the first, second, third and fourth gate signals Gate_1, Gate_2, Gate_3 and Gate_4 overlap with each other, so that the integrating part 510 may be omitted.

Alternatively, the integral signal SCI3 may be activated from the first charging period of the first gate signal Gate_1 to a period in which the level of the second sensing signal SV2 is larger than the level of the gate signal Vg, so that the integrating part 510 may integrate the first sensing signal SV1 from the first charging period of the first gate signal Gate_1 to a period in which the level of the second sensing signal SV2 is larger than the level of the gate signal Vg.

According to the present example embodiment, the first charging period has width three times larger than width of the second charging period. Alternatively, the first charging period may have width at least two times larger than width of the second charging period.

According to the present example embodiment, the gate signals have the first charging period, so that a charging time for charging the pixel electrode PE may be sufficiently guaranteed. Thus, the pixel electrode PE may be prevented from being uncharged or less charged.

In addition, the integrating part 510 decreases an integral period in which the first sensing signal is integrated, so that power consumption may be decreased.

According to the present invention, a touch unit, which detects a touch position by detecting changes of an electrostatic capacity of a conductive material, is formed on a first substrate on which a pixel electrode is formed, so that the SNR may be improved.

In addition, a gate signal having a relatively high level is used as an input signal of the touch unit, so that a relatively high output signal may be obtained. Thus, the SNR may be improved.

In addition, an integral signal which integrates the output signal during a noise-minimum period using a gate control signal controlling the gate signal is generated, so that the SNR may be improved.

Charging periods of consecutive gate signals overlap with each other, so that the period in which the output signal is integrated may be decreased. Thus, the SNR may be improved.

According to one aspect of the present disclosure of invention, the display apparatus may include a first covering part, an upper frame and a lower frame, so that a display panel may be stably fixed without additional backlight assembly having a receiving container. The first covering part is disposed on the display panel, the upper frame is attached under the first covering part, and the lower frame includes a first lower frame combined with the upper frame and a second lower frame supporting the display panel, so that transparency and structural stability of the display apparatus may be improved.

In addition, according to the present disclosure of invention, the display apparatus may be easily assembled and decomposed, so that the display apparatus may be easily manufactured and repaired.

In addition, according to the present disclosure of invention, the driving part is disposed at the first side of the display panel in a line, so that the display apparatus may have a transparent structure of the display panel and have a relatively thin frame width at the same time.

The foregoing is illustrative of the present teachings and is not to be construed as limiting thereof Although a few example embodiments in accordance with the present teachings have been described, those skilled in the art will readily appreciate from the foregoing that many modifications are possible in the example embodiments without materially departing from the novel teachings and advantages of the present disclosure of invention. Accordingly, all such modifications are intended to be included within the scope of the teachings. In the claims, means-plus-function clauses are intended to cover the structures described herein as performing the recited function and not only structural equivalents but also functionally equivalent structures. Therefore, it is to be understood that the foregoing is illustrative and is not to be construed as limited to the specific example embodiments disclosed, and that modifications to the disclosed example embodiments, as well as other example embodiments, are intended to be included within the scope of the here provided teachings.

What is claimed is:

1. A method of driving a touch display panel, the method comprising:
sequentially providing gate signals to a plurality of gate lines, the gate lines being disposed on a first surface of a base substrate, the touch display panel including the base substrate;
outputting data signals to a plurality of data lines, the data lines being disposed on the first surface and crossing the gate lines, the data signals being synchronized with the gate signals; and
reading out a first sensing signal through a plurality of sensing lines in response to the gate signals, the sensing line being disposed on a second surface of the base substrate, the second surface being opposite to the first surface.

2. The method of claim 1, further comprising:
detecting a touch position using the first sensing signal.

3. The method of claim 2, wherein the detecting the touch position comprises:
integrating the first sensing signal which is read out from at least one sensing line of the sensing lines to generate a second sensing signal, in response to each of n gate signals applied to n gate lines of the gate lines.

4. The method of claim 3, wherein the detecting the touch position comprises:
generating an integral signal based on a gate control signal controlling the n gate signals; and
integrating the first sensing signal in response to the integral signal

5. The method of claim 3, wherein the detecting the touch position comprises:
generating an integral signal based on the n gate signals; and
integrating the first sensing signal in response to the integral signal.

6. The method of claim 5, wherein a high level of the second sensing signal is substantially same as a high level of the gate signal.

7. The method of claim 6, wherein each of the n gate signals has the high level, and
the integral signal is activated during a period in which the consecutive n gate signals have the high level.

8. The method of claim 6, wherein each of the n gate signals has the high level, and
the integral signal is activated during a period in which the high levels of the consecutive two gate signals overlap with each other.

9. The method of claim 6, wherein each of the n gate signals has the high level, and
the integral signal is activated during a period in which the high levels of the consecutive n gate signals overlap with each other.

10. A touch display panel comprising:
a first substrate comprising a first base substrate and a common electrode disposed on the first base substrate; and
a second substrate comprising a unit touch sensor, the unit touch sensor comprising a second base substrate, a plurality of gate lines disposed on a first surface of the second base substrate, and at least one sensing line disposed on a second surface of the second base substrate and crossing the gate lines, the first surface facing the first base substrate, the second surface facing the first surface.

11. The touch display panel of claim 10, wherein the second substrate further comprises a data line substantially parallel with the sensing line on the first surface of the second base substrate, and
each of the sensing lines corresponds to each of the data lines.

12. The touch display panel of claim 10, wherein the second substrate further comprises a data line substantially parallel with the sensing line on the first surface of the second base substrate, and
each of the sensing line corresponds to at least two data lines.

13. A touch display apparatus comprising:
a touch display panel comprising:
a first substrate comprising a first base substrate and a common electrode disposed on the first base substrate; and
a second substrate comprising a unit touch sensor, the unit touch sensor comprising a second base substrate, a plurality of gate lines disposed on a first surface of the second base substrate, and a plurality of sensing lines disposed on a second surface of the second base substrate and crossing the gate lines, the first surface facing the first base substrate, the second surface facing the first surface; and
a driving part sequentially providing gate signals to the gate lines, and reading out a first sensing signal through the sensing lines in response to the gate signals.

14. The touch display apparatus of claim 13, wherein the driving part comprises:
a gate driving part sequentially providing the gate signals to the gate lines;
a sensing driving part reading out the first sensing signal from the sensing lines in response to each of the gate signals;
a display panel timing controller generating a gate control signal controlling the gate signal; and
a sensing timing controller generating an integral signal integrating the first sensing signal in response to the gate signals or the gate control signal.

15. The touch display apparatus of claim 14, wherein the sensing driving part comprises a integrating circuit integrating the first sensing signal to generate a second sensing signal having a level substantially same as a level of the gate signal.

16. The touch display apparatus of claim 14, wherein the sensing driving part reads out the first sensing signal from the unit touch sensor, and
the unit touch sensor reads out the first sensing signal from at least one sensing line of the sensing lines in response to each of the n gate signals applied to n gate lines of the gate lines.

17. The touch display apparatus of claim 14, wherein the sensing timing controller generates the integral signal integrating the first sensing signal during a minimum noise period based on the gate control signal.

18. The touch display apparatus of claim 14, wherein each of the gate signals has a high level, and
the sensing timing controller generating an integral signal integrating the first sensing signal during a period in which the consecutive gate signals have the high level.

19. The touch display apparatus of claim 14, wherein each of the gate signal has a high level, and
the sensing timing controller generating an integral signal integrating the first sensing signal during a period in which the high levels of the consecutive two gate signals overlap with each other.

20. The touch display apparatus of claim 14, wherein each of the gate signal has a high level, and
the sensing timing controller generating an integral signal integrating the first sensing signal during a period in which the high levels of the consecutive gate signals overlap with each other.
